(19) United States
(12) Patent Application Publication
(10) Pub. No.: US 2016/0267669 A1
(43) Pub. Date: Sep. 15, 2016

(54) 3D Active Warning and Recognition Environment (3D AWARE): A low Size, Weight, and Power (SWaP) LIDAR with Integrated Image Exploitation Processing for Diverse Applications

(71) Applicants: James W. Justice, Newport Beach, CA (US); Medhat Azzazy, Laguna Niguel, CA (US); ltzhak Sapir, Irvine, CA (US)

(72) Inventors: James W. Justice, Newport Beach, CA (US); Medhat Azzazy, Laguna Niguel, CA (US); ltzhak Sapir, Irvine, CA (US)

(21) Appl. No.: 15/064,797

(22) Filed: Mar. 9, 2016

Related U.S. Application Data
(60) Provisional application No. 62/132,160, filed on Mar. 12, 2015.

(51) Int. Cl. G06T 7/00; G01S 7/486; G02B 26/10; G06K 9/00; G02B 5/32; G01S 17/89; H04N 5/33

(52) U.S. Cl. CPC G06T 7/0057; G01S 17/89; G01S 7/4865; G01S 7/4861; H04N 5/33; G06K 9/00201; G06K 9/00671; G02B 5/32; G02B 26/105; G06K 2209/401

(57) ABSTRACT

An invention is disclosed for a multi-mode LIDAR sensor system that embodies a high pulse rate fiber laser operating in the SWIR wavelength at 1.5 microns, a long linear array of small SWIR sensitive detectors with very high speed readout electronics, and fully integrated methods and processing elements that perform target detection, classification, and tracking using techniques that emulate how the human visual path processes and interprets imaging data. High resolution three dimensional images are created of wide areas. Image exploitation processing methods detect objects and object activities in real time thus enabling diverse applications such as vehicle navigation, critical infrastructure protection, and public safety monitoring.

### CROSS-REFERENCE TO RELATED APPLICATIONS

This application claims the benefit of U.S. Provisional Patent Application No. 62/132,160 filed on Mar. 12, 2015 entitled “3D Active Warning and Recognition Environment (3D AWARE): A Low Size, Weight, and Power (SWaP) LIDAR with Integrated Image Exploitation Processing for Diverse Applications”, pursuant to 35 USC 119, which application is incorporated fully herein by reference.

### STATEMENT REGARDING FEDERALLY SPONSORED RESEARCH AND DEVELOPMENT

N/A

### FIELD OF THE INVENTION

The invention relates generally to the field of Three Dimensional Imaging LIDARS. More specifically, the invention relates to a LIDAR assembly with integrated image exploitation processing which can perform high resolution, wide area 3D imaging for multiple applications and provide real-time assessments of scene content.

### BRIEF DESCRIPTION OF THE PRIOR ART

LIDAR systems produce image data in three dimensions due to their capability to measure the range to objects in scenes as well as the two dimensional spatial extent of objects in scenes. This is accomplished by scanning a narrow laser beam over the elements of the scene to be observed, typically a very slow process. Larger scenes can be measured by such 3D LIDARS if multiple lasers or emitters are used in parallel. Mechanical mechanisms, typically cumbersome and typically requiring high power to operate, are used to point or scan the laser beams over even larger areas. Current systems produce high resolution 3D images but typically require significant times. These features of the current state of the art in 3D Imaging LIDARS when performing wide area imaging applications result in complex and costly systems. Lasers used in these applications typically operate at visible and near visible wavelengths. Such systems are rendered “eye safe” by rapidly scanning the beams in such a fashion that eye damage levels are not reached in the areas of operation. The eye safe feature fails if the scanning mechanisms stop and the laser energy is continuously deposited at the same small angles for longer periods of time.

Prior art in 3D Imaging LIDARS accomplish their missions by examining the three dimensional images produced and determining their object content. Methods employed are based on template matching to the spatial models of the characteristics of the objects being observed. These techniques do not produce accurate object classifications and do not provide data for activity interpretation.

### BRIEF SUMMARY OF THE INVENTION

The invention is a 3D LIDAR system which operates in an eye safe mode under all the systems operating conditions, provides high resolution, wide area 3D imaging with long detection ranges, provides an order of magnitude better spatial resolution compared to current systems, is mechanically simplified compared to current systems, has a small form factor compared to current systems, and has a fully integrated, real-time image processing and exploitation capability that accurately determines scene object content and has sufficient relook times to enable activity observation and interpretation.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

The invention and its various embodiments can now be better understood by turning to FIGS. 1, 2, 3, 4, 5, 6, and 7 and the description of the preferred embodiments which are presented as illustrated examples of the invention in any subsequent claims in any application claiming priority to this application.

FIG. 1 identifies the principle physical features of the low SWaP 3D LIDAR invention and their arrangement.

FIG. 2 shows the electronic design elements of the 3D AWARE LIDAR.

FIG. 3 presents the specific design parameters for the exemplar 3D AWARE LIDAR.

FIG. 4 presents the image processing and exploitation method used for cognitive processing of two dimensional imagery.

FIG. 5 shows the conceptual method of incorporating the extension of cognitive processing to three dimensions into the method for cognitive processing in two dimensions.

FIG. 6 provides the details on the integration of 3D Image data into the two dimensional image processing architecture.

FIG. 7 presents 3D images taken by the initial development model of the invention.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

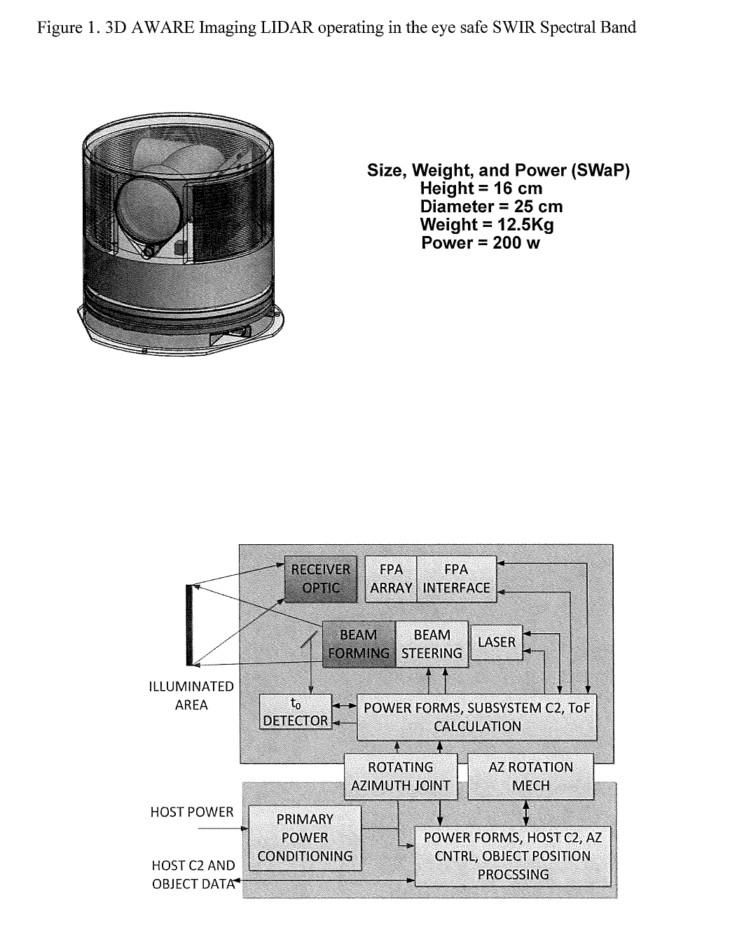

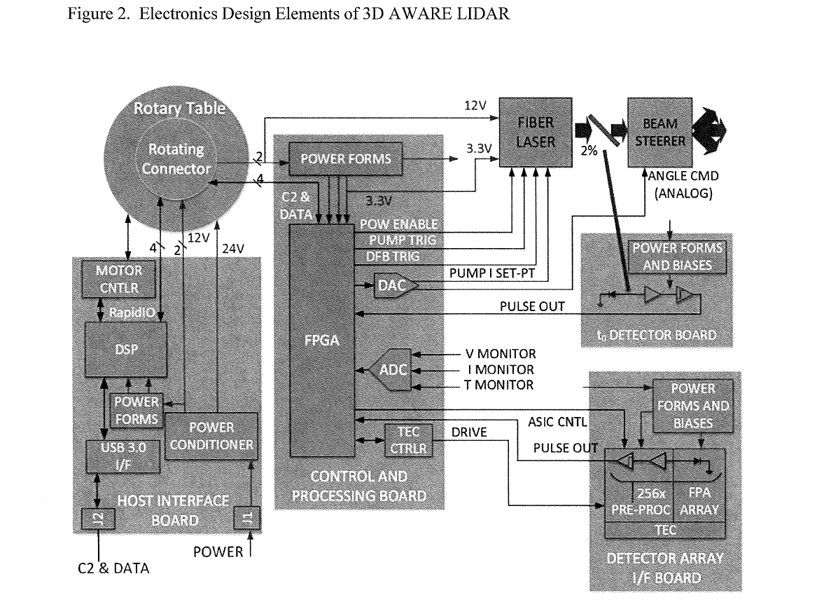

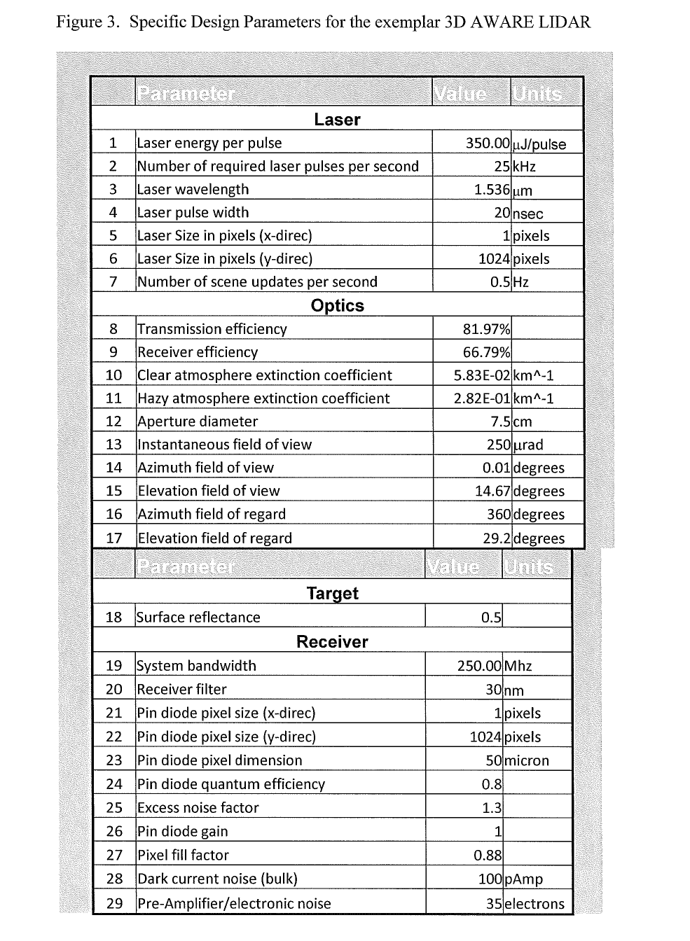

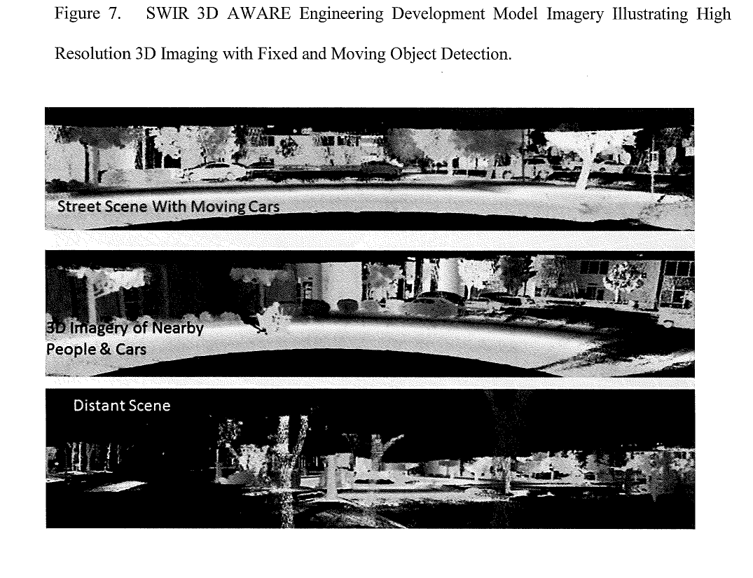

The method and apparatus of the 3D AWARE LIDAR system disclosed herein operates using a single eye safe laser with very high pulse rates but very low energy per pulse. The eye safe feature of this laser is inherent in its operating wavelength which is 1.54 microns in the SWIR spectral region. No human eye damage can occur even if the 3D LIDAR scanning mechanisms are not operating properly. The small laser is mounted below the optical elements in the lower design element of 3D AWARE LIDAR which is illustrated in FIG. 1. The laser and optical elements of the embodiment rotate as a unit at various speeds that are determined by the application needs. For example, long detection ranges needed by wide area, infrastructure protection missions can be achieved by setting the rotation rate to typically 1 Hz. A holographic optical element is integrated with the laser's output and shapes the exiting laser beam into a top hat form providing uniform illumination over multiple pixels in the detection array. The holographic element shapes the outgoing beam into a mission appropriate angular size, typically 5 to 10 degrees, elevation beam with uniform illumination. In this exemplar design, the outgoing beam covers 256 elevation spatial samples and one azimuth spatial sample per pulse. Elevation scanning is required for this mode of operation in order to achieve an elevation field of regard of typically 30 degrees. The elevation scanning is accomplished by a nonlinear optical element in the transmit beam Azimuth scanning is accomplished by rotation of the upper chamber. The returns from scene elements are received by a focal plane array which is matched to the outgoing beam field of regard and consists of 1024 InGaAs pin diodes in a linear array. Fast time samples of each of these detectors enable objects to be detected and their ranges determined within each of the 1024 pixels of the array. Range measurements better than 10 cm can be obtained throughout a 360 degree azimuth by 30 degree elevation field of regard. The high resolution instantaneous field of view of each pixel is 0.5 milliradian which produces a high resolution spatial picture of the scene as the high resolution range data is also being obtained. This is illustrated in scene data taken by an engineering development model and shown in FIG. 7's top and center images. A receiver telescope is positioned in the center of the upper chamber to capture the returning photons reflected from the scene elements. These measurements are then transmitted to the signal processor which accomplishes the image exploitation processing and display processing for the system user. The electronics method that controls the LIDAR operation is illustrated in FIG. 2. Specific design parameters for the exemplar design are listed in FIG. 3. The design, as illustrated in the attached FIGS. 1, 2 and 3, integrates these elements and achieves a compact, highly flexible multimode 3D LIDAR system which operates in an eye safe manner in all modes. This exemplar embodiment of the 3D AWARE LIDAR system results in a basically cylindrical design with diameter of 25 cm (9.84 inches) and a height of 16 cm (6.30 inches) capable of rapid azimuthal rotation. The low SWaP design numbers are listed in FIG. 1.

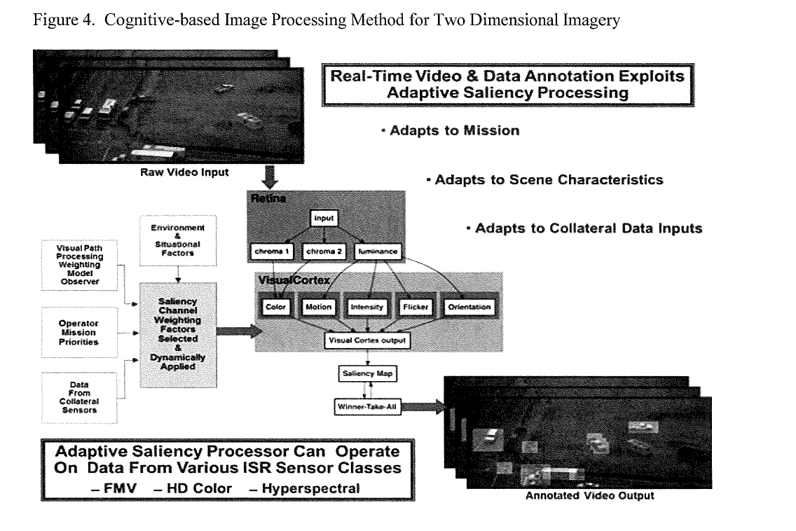

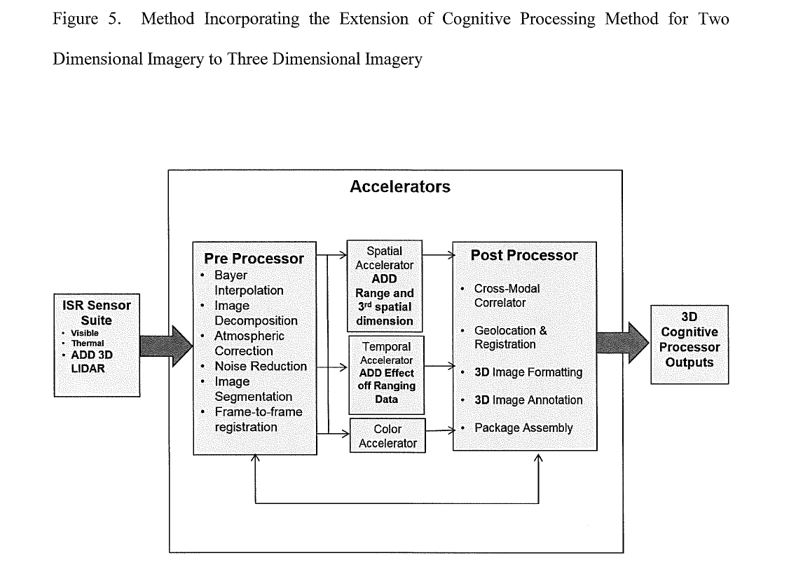

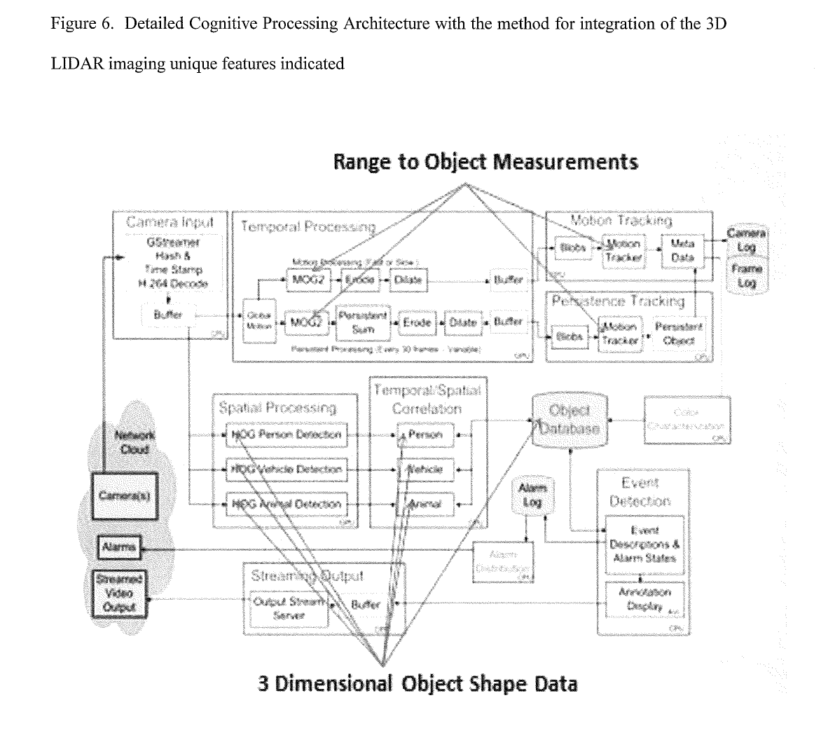

A most important innovation of the 3D AWARE LIDAR approach is the integration of real-time image exploitation processing methods which determine the object content of the 3D images and, with analysis of multiple frames, determines the activities of objects of high interest or importance to the system users. The 3D AWARE image exploitation processing is based upon a method which emulates how the human visual path (eye, retina, and cortex) processes and interprets image data. The human visual path exploits shape, motion, and color information to determine objects or activities of interest to the observer. The two dimensional method for accomplishing the cognitive image processing is illustrated in FIG. 4. Added dimensional data provided by the 3D LIDAR operation occurs in several ways. First, a precise measurement of the range to all objects within the observed scene is obtained. This enables improved track detection and track maintenance on moving objects. It also enables the quantitative determination of absolute spatial scale of all observed objects in the scene. This feature, unavailable in two dimensional imaging systems, enables a significant reduction in false positive classifications of observed objects when compared to the results of two dimensional imaging systems where absolute spatial scale is typically indeterminate. Second, objects are resolved in the range dimension as well as spatial dimensions. This provides an additional axis of resolved information exploited for the purpose of improved target classification and recognition. The integration of the range to object data and range resolved object imagery with the two dimensional cognitive technique is illustrated in conceptually in FIG. 5 and in detail in FIG. 6. Third, the observer of the wide area three dimensional scene images can place himself anywhere within the area observed thus shifting perspective on the observed objects within the scene. This feature, illustrated in FIG. 7's lower image, also contributes to improved target classification and recognition by allowing targets to be observed against different foreground and background scene views.

The cognitive image processing is accomplished in a massively parallel fashion across the eye, retina, cortex of the visual path. The electronic emulation of this processing is likewise accomplished in a massively parallel fashion which is achieved by hosting the processing on Graphics Processing Units (GPUs) which embody the parallel processing architecture needed for efficient human visual path processing emulation.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a sub combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A method and apparatus in the form of a multi-mode LIDAR sensor system comprising 1) a single laser, 2) a single receiver telescope with its associated focal plane array and read out circuity, 3) a holographic optical element that shapes the outgoing beam, 4) a nonlinear optical element that scans the outgoing beam in elevation, 5) integrated signal processing elements that compute range of detected scene elements and form three dimensional images of the illuminated scenes, 6) integrated image exploitation processing elements that determine the object content and object activities within the observed scenes in real time, and 7) integrated processing elements that inform system users of scene content in order to enable timely mission required actions.

2. The single laser of claim 1 further comprising a laser which operates in the eye safe SWIR spectral region and is a high repetition fiber laser.

3. The beam forming element of claim 1 further comprising optical devises that transform the shape of the beam when it leaves the laser into desired shapes to provide a selected illumination pattern covering the field of view to be observed.

4. The elevation scanning element of claim 1 further comprising a galvo scanner or a nonlinear beam steering element that enables the transmit beam to access all of the elevation field of regard.

5. The single receiver telescope of claim 1 further comprising a wide field of view optical instrument that images the returned SWIR pulses on its focal plane array.

6. The receiver of claim 1 further comprising a SWIR sensitive focal plane array with integrated electronics and associated processing elements which measures the time of flight of a transmitted pulse when it is detected by the receiver focal plan array elements.

7. The azimuth scanning element of claim 1 further comprising a platform providing a 360 degree azimuth rotation range and capable of providing a variable azimuth from rate supporting the systems multiple missions.

8. The signal processing elements of claim 1 further comprising a) elements computing the range to scene elements that have returned the laser pulse to the receiver with sufficient strength to be detected, and b) elements that transform the three dimensional point cloud images thus produced into wide area scene images.

9. The image exploitation processing elements of claim 1 further comprising computation devices operating in the highly parallel processing modes required of the human visual path emulation image exploitation methods.

10. The mission alerting processing elements of claim 1 further comprising computation devices interpreting scene content and providing the system user with information required for mission execution.
